(19) United States
(12) Patent Application Publication
(10) Pub. No.: US 2015/0185001 A1
(43) Pub. Date: Jul. 2, 2015

(54) LASER DETECTION DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HSIU-LUNG CHANG, New Taipei (TW); LIANG ZHANG, Shenzhen (CN); WEI YANG, Shenzhen (CN)

(21) Appl. No.: 14/580,559

(22) Filed: Dec. 23, 2014

(30) Foreign Application Priority Data
Dec. 27, 2013 (CN) 201310734852.9

(51) Int. Cl. G01B 11/24; G01B 11/14; G01B 11/26; G01B 11/30

(52) U.S. Cl. CPC G01B 11/24; G01B 11/30; G01B 11/14; G01B 11/26

(57) ABSTRACT

A laser detection device includes a mounting member, a laser displacement sensor fixed on the mounting member, and a reflective member. The laser displacement sensor includes a laser transmitting head configured to emit laser beams to a workpiece along a first line of direction, and a laser receiving head coupled to the laser transmitting head and configured to receive the laser beams reflected from the workpiece. The reflective member includes a prism fixed on the mounting member, and spaced away from the laser displacement sensor. The prism has a reflective surface on an incline with the first line of direction and configured to reflect a part of the laser beams via the reflective surface to the workpiece along a second line of direction different from the first direction. The part of the laser beams are directly reflected or reflected via the prism to the laser receiving head.

### FIELD

The subject matter herein generally relates to a detection device and in particular to a laser detection device.

### BACKGROUND

Laser detection devices transmit a coherent light beam at targets and measure various aspects of these targets using backscattered light from the light beam.

### BRIEF DESCRIPTION OF THE DRAWINGS

Implementations of the present technology will now be described, by way of example only, with reference to the attached figures.

FIG. 1 is an isometric view of an embodiment of a laser detection device.

FIG. 2 is a partially exploded, isometric view of the laser detection device of FIG. 1.

FIG. 3 is similar to FIG. 1, but showing the laser detection device in a used state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A laser detection device can include a mounting member, a laser displacement sensor fixed on the mounting member, and a reflective member. The laser displacement sensor can include a laser transmitting head configured to emit laser beams to a workpiece along a first line of direction, and a laser receiving head coupled to the laser transmitting head and configured to receive the laser beams reflected from the workpiece. The reflective member can include a prism fixed on the mounting member, and spaced away from the laser displacement sensor. The prism can have a reflective surface on an incline with the first line of direction and configured to reflect via the reflective surface to the workpiece along a second line of direction which is different from the first line of direction, and a part of the laser beams which are reflected via the prism to the laser receiving head.

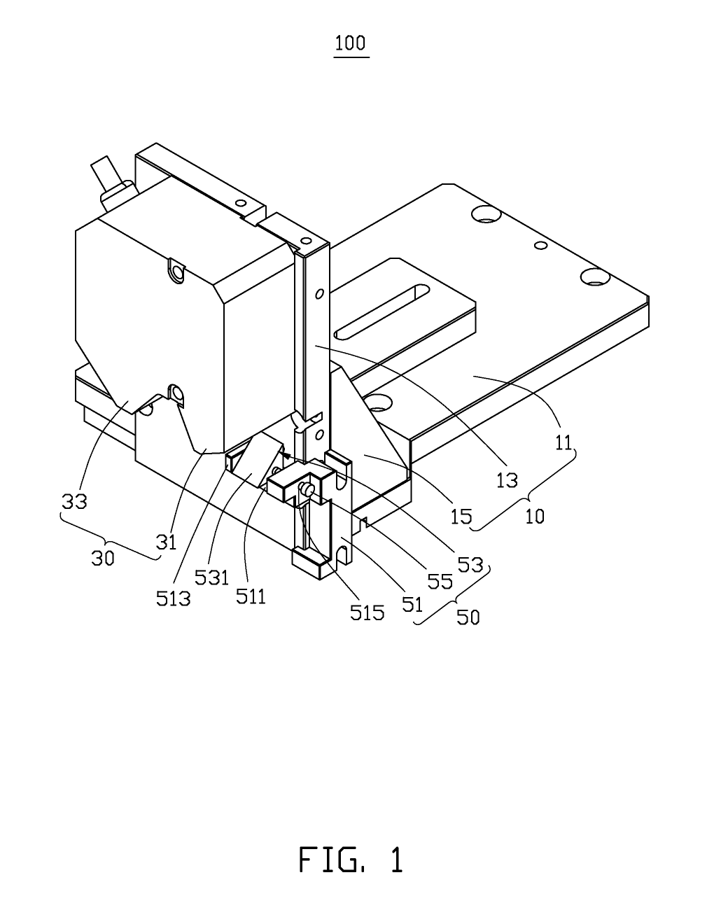

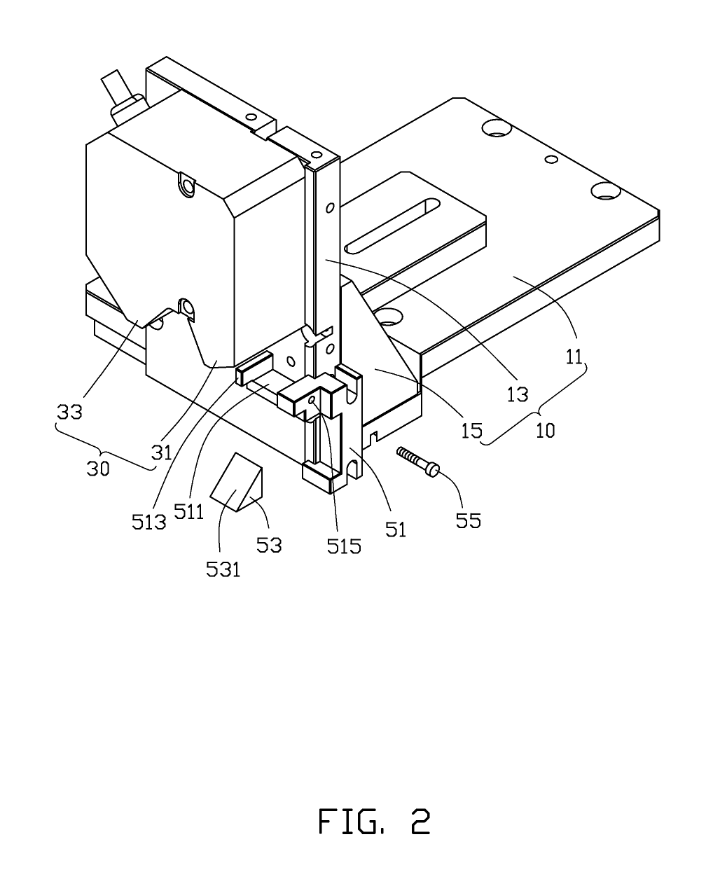

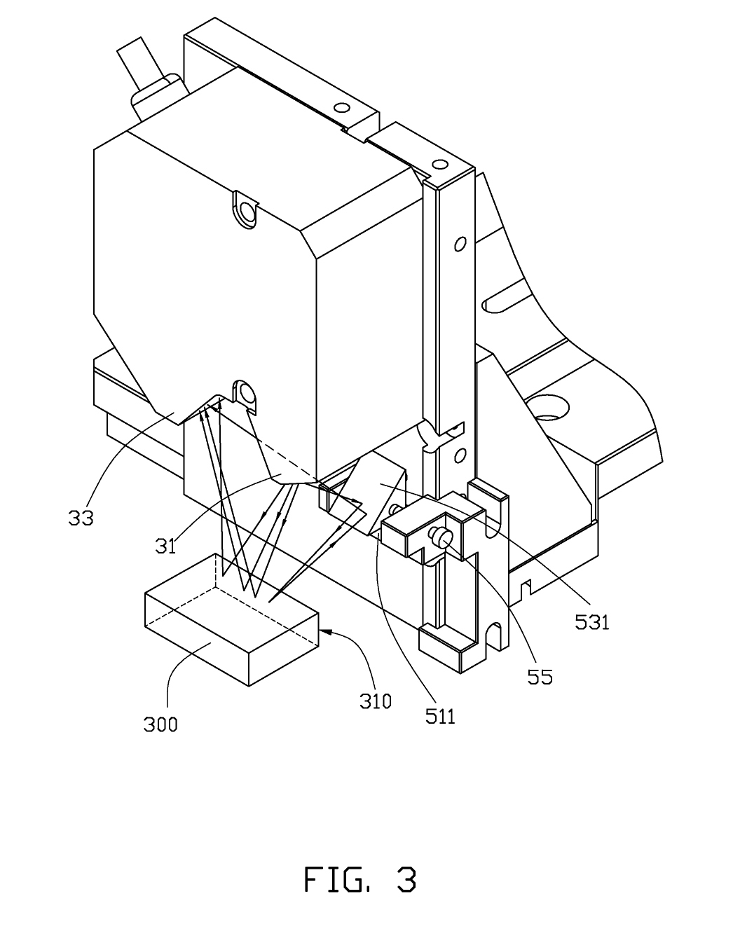

FIGS. 1 and 2 illustrate an embodiment of a laser detection device 100. The laser detection device 100 can be configured to obtain the data of the outline of a workpiece 300 (as shown in FIG. 3) to calculate the size, the straightness, the perpendicularity, and the flatness of the workpiece 300. The laser detection device 100 can include a mounting member 10, a laser displacement sensor 30, and a reflective member 50.

The mounting member 10 can be substantially an L-shaped plate, and can include a support portion 11, a mounting portion 13, and two reinforced portions 15. The mounting portion 13 can protrude out from a side of support portion 11, and can be substantially vertical to the support portion 11. Each reinforced portion 15 can be securely coupled to the support portion 11 and the mounting portion 13. The two reinforced portions 15 can be located on a same end of the support portion 11. The reinforced portion 15 can be configured to strengthen the support portion 11 and the mounting portion 13. In at least one embodiment, the number of the reinforced portions 15 can be changed as needed, such as one.

The laser displacement sensor 30 can be fixed on an end of the mounting portion 13 away from the support portion 11, and can include a laser transmitting head 31 and a laser receiving head 33 which is coupled to the laser transmitting head 31. The laser transmitting head 300 can be configured to transmit a number of laser beams to the workpiece 300 along a first line of direction. The laser receiving head 33 can be configured to receive laser beams which are reflected by the workpiece.

The reflective member 50 can be fixed on an end of the mounting portion 13 away from the laser displacement sensor 30. The reflective member 50 can include a connecting portion 51, a prism 53, and a screw 55. The connecting portion 51 can be fixed on an end of the mounting portion 13 away from the laser displacement sensor 30. The connecting portion 51 can define a mounting groove 511. The mounting groove 511 can include two opposite side walls 513, and one side wall 513 can define a screw hole 515 which communicates with the mounting groove 511. The prism 53 can be received in the mounting groove 511, and can be spaced a predetermined distance from the laser displacement sensor 30. The prism 53 can have a reflective surface 531 on an incline with a first line of direction. In at least one embodiment, the prism 53 can be a triangular prism.

The screw 55 can be screwed into the screw hole 515 to push the prism 53; the prism 53 can be pushed to be in touch with the side wall 513 away from the screw hole 515. In this way, the prism 53 can be securely received in the mounting groove 511, and the prism 53 can be spaced a predetermined distance from the mounting portion 13 of the mounting member 10. In at least one embodiment, the screw 55 can be other fasteners with threads.

FIG. 3 illustrates when in use, the laser transmitting head 31 can emit the laser beams along the first line of direction. A part of the laser beams can be directly transmitted to the workpiece 300, and then be reflected to the laser receiving head 33 via the workpiece 300. Another part of the laser beams can be directly transmitted to the prism 53, and then be reflected to the peripheral wall 310 of the workpiece 300 along a second line of direction which is different from the first line of direction via the reflective surface 531 of the prism 53, and then be reflected to the prism 53 by the peripheral wall 310, and then be reflected to the laser receiving head 33 via the prism 53. In this way, the laser receiving head 33 can obtain the data of the whole outline of the workpiece 300. The laser receiving head 33 can process the data to calculate the size, the straightness, the perpendicularity, and the flatness of the workpiece 300.

In at least one embodiment, the another part of the laser beams can be reflected to the periphery wall 310 through the prism 53 along the second line of direction , and then be directly reflected to the laser receiving head 33 via the periphery wall 310.

In at least one embodiment, the number of the prisms 53 can be changed as needed, for example, the laser detection device 100 can include four prisms 53 arranged around the workpiece 300. In at least one embodiment, the connecting portion 51 and the screw 55 can both be omitted, the prism 53 can be fixed on the mounting member 10 by other methods, such as using an adhesive.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure, as defined by the appended claims.

What is claimed is:

1. A laser detection device comprising:
a mounting member;
a laser displacement sensor fixed on the mounting member, and comprising:
a laser transmitting head configured to emit laser beams to a workpiece along a first line of direction; and
a laser receiving head coupled to the laser transmitting head and configured to receive laser beams reflected from the workpiece; and
a reflective member comprising:
a prism fixed on the mounting member, spaced away from the laser displacement sensor, having a reflective surface on an incline with the first line of direction, and configured to reflect via the reflective surface to the workpiece along a second line of direction which is different from the first line of direction, and a part of the laser beams which are reflected via the prism to the laser receiving head.

2. The laser detection device of claim 1, wherein the reflective member further comprises a connecting portion fixed on an end of the mounting member away from the laser displacement sensor, and the prism is securely coupled to the connecting member.

3. The laser detection device of claim 2, wherein the connecting member defines a mounting groove configured to receive the prism.

4. The laser detection device of claim 3, wherein the mounting groove comprises two opposite side walls, one side wall defines a screw hole, the reflective member further comprises a fastener screwed into the screw hole and pushing the prism to be in touch with another side wall.

5. The laser detection device of claim 1, wherein the mounting member comprises a support portion, and a mounting portion perpendicularly protruding from a side of the support portion, the laser displacement sensor and the prism both are fixed on the mounting portion.

6. The laser detection device of claim 5, wherein the mounting member further comprises a reinforced portion securely coupled to the support portion and the mounting portion.

7. The laser detection device of claim 1, wherein the prism is a triangular prism.
